(19) United States
(12) Patent Application Publication
(10) Pub. No.: US 2016/0292685 A1
(43) Pub. Date: Oct. 6, 2016

(54) AUTHENTICATING A USER WITH A PASSCODE USING A PASSCODE ENTRY TABLE

(71) Applicant: CA, INC., New York, NY (US)

(72) Inventor: Gangadhar Kairi, Hyderabad (IN)

(73) Assignee: CA, INC., New York, NY (US)

(21) Appl. No.: 14/675,185

(22) Filed: Mar. 31, 2015

(51) Int. Cl. G06Q 20/40

(52) U.S. Cl. CPC G06Q 20/4012

(57) ABSTRACT

Authenticating a user with a passcode using a passcode entry table includes a sequence of characters and a location within a grid associated with each character, wherein entry of the passcode is performed using a displayed passcode entry table comprising a number of selectable cells, where selection of a cell enters a character of a passcode being entered, each cell including a number of different characters in different grid locations displaced within the cell, such that the entry of one particular character in the passcode is made by selecting a cell. The method includes receiving an entered passcode, the entered passcode comprising a series of selected cells, and verifying that each sequentially selected cell matches a corresponding character of the passcode, as to both the corresponding character of the passcode and that character displayed at a corresponding grid location within the selected cell.

### BACKGROUND

In many systems, a user is authenticated by providing some identifier, such as a user name, and also by knowing a password or passcode that is associated with the user identifier. In a related example, the user of an automated teller machine (ATM) may use an ATM card to identify an account associated with the user and then enter a passcode to verify that the person using the card is the account holder.

However, when an authorized user is accessing any such secured system, the user may be observed entering the user identifier and/or the associated passcode. This may enable the observer to gain unauthorized access to the secured system by impersonating the authorized user.

### BRIEF SUMMARY

According to one aspect of the present disclosure, a method is implemented for authenticating a user with a passcode, the passcode includes a sequence of characters and a location within a grid associated with each character. Entry of the passcode is performed using a displayed passcode entry table that includes a number of selectable cells, where selection of a cell enters a character of a passcode being entered. However, each cell includes a number of different characters in different grid locations displayed within the cell, such that the entry of one particular character in the passcode is made by selecting a cell, the corresponding display of which includes the particular character of the passcode displayed at the correct corresponding grid location within the cell. The selection is made irrespective of other characters also displayed at other grid locations in that cell. Thus, the method includes receiving an entered passcode, the entered passcode comprising a series of selected cells, each cell representing a plurality of different characters arranged at different grid locations within the cell, and verifying that each sequentially selected cell matches a corresponding character of the passcode as to both the corresponding character of the passcode and that character displayed at a correct corresponding grid location within the selected cell, When the sequentially selected cells do not match the corresponding characters of the passcode as to both the character and the grid location corresponding to the character, the entry of the passcode is incorrect, and the user is not authenticated.

According to another aspect of the present disclosure, a system for authenticating a user with a passcode is described. As above, the passcode includes a sequence of characters and a location within a grid associated with each character. Entry of the passcode is performed using a displayed passcode entry table that includes a number of selectable cells, where selection of a cell enters a character of a passcode being entered. However, each cell includes a number of different characters in different grid locations displayed within the cell, such that the entry of one particular character in the passcode is made by selecting a cell, the corresponding display of which includes the particular character of the passcode displayed at the correct corresponding grid location within the cell. The selection is made irrespective of other characters also displayed at other grid locations in that cell. The system includes a processor, memory, communicatively connected to the processor, a computer display, displaying information directed by the processor, and a passcode authenticating system. The passcode authenticating system includes an assigning module, to assign a character to each grid location within a cell, wherein a single character may appear in multiple cells of the entry table at different grid locations within those respective cells, and a displaying module, to display the passcode entry table, the displaying showing each grid location in each cell in the passcode entry table. The system further includes a receiving module, to receive an entered passcode, the entered passcode comprising a series of selected cells, each cell representing a plurality of different characters arranged at different grid locations within the cell, and a verifying module, to verify that each sequentially selected cell matches a corresponding character of the passcode, as to both the corresponding character of the passcode and that character displayed at a corresponding grid location within the selected cell. When the sequentially selected cell does not match the corresponding character of the passcode as to both the character and the grid location corresponding to the character, the entry of the passcode is not authenticated.

According to another aspect of the present disclosure, a computer program product for authenticating a user with a passcode, the passcode includes a sequence of characters and a location within a grid associated with each character. Entry of the passcode is performed using a displayed passcode entry table that includes a number of selectable cells, where selection of a cell enters a character of a passcode being entered. However, each cell includes a number of different characters in different grid locations displayed within the cell, such that the entry of one particular character in the passcode is made by selecting a cell, the corresponding display of which includes the particular character of the passcode displayed at the correct corresponding grid location within the cell. The selection is made irrespective of other characters also displayed at other grid locations in that cell. The computer program product includes a non-transitory tangible computer readable storage medium, said tangible computer readable storage medium including computer readable program code embodied therewith, said computer readable program code comprising program instructions that, when executed, cause a processor to perform the designated function. The computer program code causes the processor to receive an entered passcode, the entered passcode comprising a series of selected cells, each cell representing a plurality of different characters arranged at different grid locations within the cell, and, to verify that each sequentially selected cell matches a corresponding character of the passcode, as to both the corresponding character of the passcode and that character displayed at a corresponding grid location within the selected cell, wherein, when the sequentially selected cell does not match the corresponding character of the passcode as to both the character and the grid location corresponding to the character, the entry of the passcode is not authenticated.

### BRIEF DESCRIPTION OF THE DRAWINGS

Aspects of the present disclosure are illustrated by way of example and are not limited by the accompanying figures, with like references indicating like elements.

FIGS. 1A and 1B illustrate a generalized and specific example, respectively, of a system for authenticating a user using a passcode entry table, according to principles described herein.

FIG. 2 illustrates a system for authenticating a user using a passcode entry table, according to one example of the principles described herein.

FIG. 3 illustrates a diagram of a cell with a grid creating a number of grid locations, according to the principles described herein.

FIG. 4 illustrates a flowchart of a method implemented by a user authenticating system, according to one example of the principles described herein.

FIG. 5 illustrates a flowchart of a method implemented by a user authenticating system, according to one example of the principles described herein.

FIG. 6 illustrates a diagram of an authenticating system, according to one example of the principles described herein.

FIG. 7 illustrates a diagram of a computer program product for authenticating a user, according to one example of the principles described herein.

Throughout the drawings, identical reference numbers designate similar, but not necessarily identical, elements.

### DETAILED DESCRIPTION

The present specification describes a method and system for limiting the ability of an observer to watch an authorized user entering credentials such as a passcode, with the intent of then gaining unauthorized access to the secured system by impersonating the authorized user. As described herein, an authorized user enters a passcode using a passcode entry table. The passcode entry table may be, for example, a virtual keypad displayed on a touch-sensitive display with which the user can securely enter a passcode. The passcode entry table includes a plurality of cells, which correspond conceptually to the keys on a physical keypad. Each cell comprises a grid that divides the cell into a plurality of grid locations. The passcode entry table is populated with characters for the entry of a user passcode. Each character is associated with a respective grid location. Consequently, each cell or “key” will include a plurality of characters at different grid locations within the cell. Knowledge of the correct passcode will include a sequence of characters and a grid location within a cell associated with each character. Consequently, an observer might see which cells a user selects to enter a passcode, but will not know which of the several characters at different grid locations in that cell is actually part of the passcode. Upon a subsequent authentication, the passcode entry table will repopulate with different cells including different characters. Consequently, unless a user knows both the sequence of characters in the passcode and a grid location associated with each character, it will not be possible to enter the passcode correctly based on previous observation of the passcode being entered on the entry table.

The subject matter described herein may be a system, a method, and/or a computer program product. The computer program product may include a computer readable storage medium (or media), having computer readable program instructions thereon for causing a processor to carry out aspects of the subject matter described herein.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented as entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but is not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions, when stored in the computer readable medium, produce an article of manufacture including instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function, in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

As noted above, when authorized users make use of electronic information for identification with a secured system, other individuals may attempt to gain access to this system illicitly. Criminals may gain access to a secured system or user account by observing an authorized user entering a passcode in order to obtain the passcode for future use by impersonating that authorized user. The proliferation of video recording equipment increases the opportunity for criminals to gain access to a secured system by recording transactions for which a user enters a passcode. For example, a retailer may compromise passcode information by installing video surveillance of transactions at a retail register, inadvertently recording the entry of a passcode. Someone else may then gain illicit access to the surveillance film and observe the user entering the passcode. Even without a clear view of a passcode entry device, an observer may from the motions made while entering a passcode determine what the passcode is.

To prevent this, the present specification describes a method and system for authenticating a user with a passcode, where observation of one entry of the passcode will not reveal the passcode, or enable the observer to subsequently enter the passcode correctly if impersonating the authorized user. As noted above, the passcode includes a sequence of characters and a location within a grid associated with each character. Entry of the passcode is performed using a displayed passcode entry table that includes a number of selectable cells, where selection of a cell enters a character of a passcode being entered. However, each cell includes a number of different characters in different grid locations within the cell, such that the entry of one particular character in the passcode is made by selecting a cell, the corresponding display of which includes the particular character of the passcode, displayed at the correct corresponding grid location within the cell, irrespective of other characters also displayed at other grid locations in that cell.

Upon entry of an entered passcode, the entered passcode must comprise a series of selected cells, each cell representing a plurality of different characters arranged at different grid locations within the cell, such that each sequentially selected cell matches a corresponding character of the passcode as to both the corresponding character of the passcode and that character displayed at a correct corresponding grid location within the selected cell. When the sequentially selected cell does not match the corresponding character of the passcode as to both the character and the grid location corresponding to the character, the entry of the passcode is incorrect, and the user is not authenticated.

As used in the present specification and in the appended claims, the term “character” refers to a symbol used in a writing system. For example, the numbers zero through and including nine are characters. The letters A through Z are also characters. Other written symbols or letters from other alphabets are also characters.

As used in the present specification and in the appended claims, the term “passcode” refers to a string of characters used to authenticate an authorized user and to gain access to a secured system, such as a computing device, website, database, financial or banking system, etc. Access may be gained to a device or to an account accessed by a device. An example of a passcode includes a personal identification number (PIN). A PIN is used to authenticate a user of a debit card or credit card at an ATM or point of sales transaction.

As used in the present specification and in the appended claims, the term “entered passcode” refers to a passcode entered by a user who has not been authenticated. An entered passcode is compared against information stored about an authorized user. The term “user passcode” refers to a passcode stored in a system that corresponds to an authorized user. An entered passcode is compared to a user passcode. When an entered passcode matches the user passcode, the person who entered the entered passcode is authenticated as an authorized user. When an entered passcode does not match a user passcode, the user is denied access.

As used in the present specification and in the appended claims, the term “cell” refers to an input unit in a passcode entry table. A user selects cells within a passcode entry table when entering a passcode. Conceptually, a cell corresponds to the key of a keypad for entering a character of a passcode. As described herein, the cells of a passcode entry table are, for example, virtual keys displayed on a touch-sensitive display. Additionally, each cell is divided into a grid with different locations at which characters may be displayed.

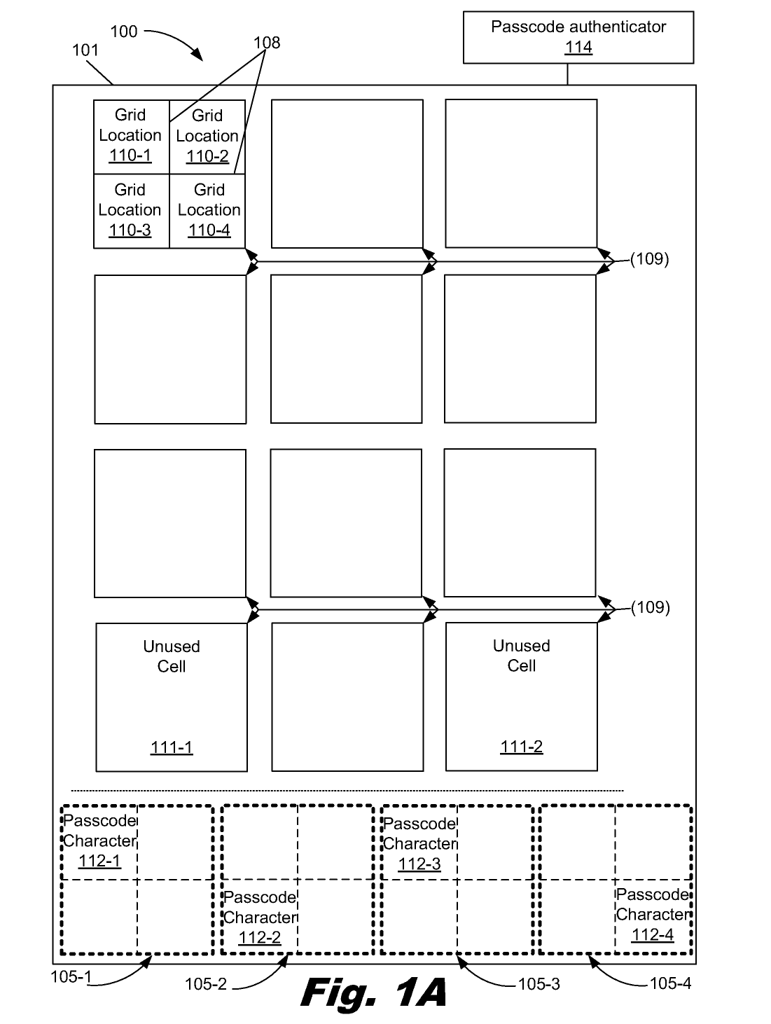

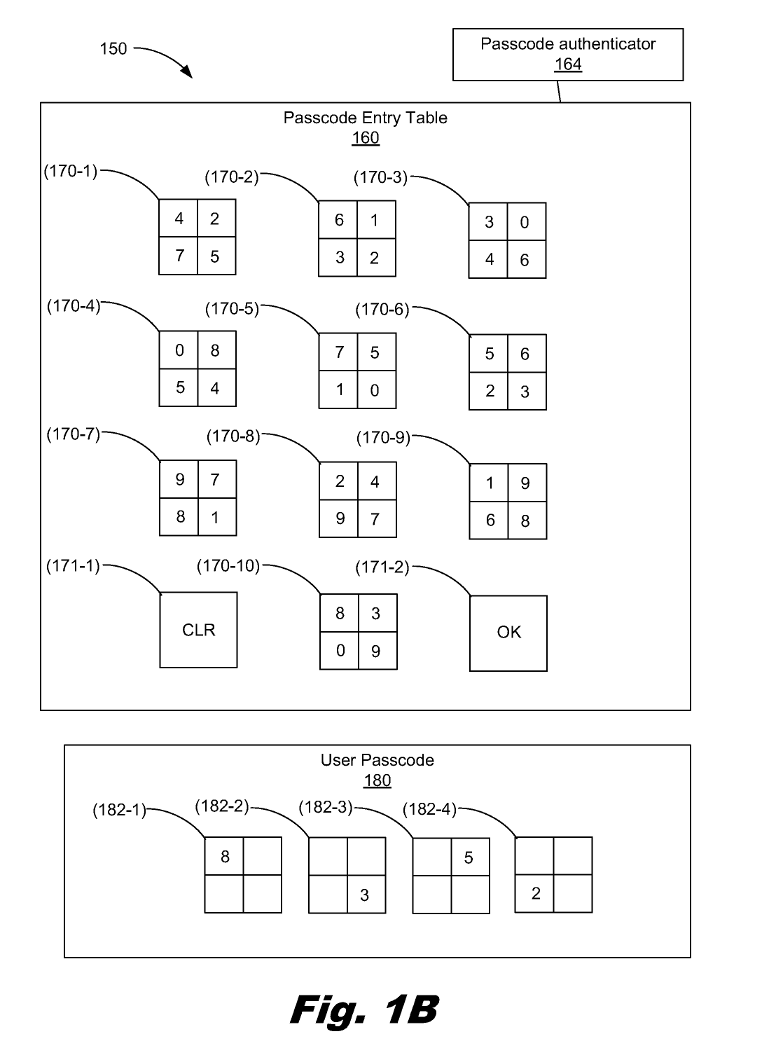

Referring now to the figures, FIG. 1A illustrates on example of a passcode entry table as described above. The illustrated passcode system (100) includes a passcode entry table (101). The passcode entry table includes a rectangular array of cells (109). At least some of the cells (105, 109) contain a grid (108). Each grid forms a number of grid locations (110, 112) within that cell, for example, four quadrants. As described above, a user uses the passcode entry table to enter a passcode to authenticate the identity of the user. The user selects a series of cells in the passcode entry table. Each cell selected by the user corresponds to a character in a user passcode. A passcode authenticator receives the series of cells selected from the passcode entry table. The passcode authenticator verifies that each character in an entered passcode matches both the corresponding character and an associated grid location within a user passcode for an authorized user. An entered passcode that is successfully authenticated gains access to the system.

When a passcode is being established for an authorized user, the entry table (100) may include display of a number of configuration cells (105). Each configuration cell (105) is divided by a grid in the same configuration as the cells (109) that are subsequently used for entry of a passcode. A new passcode is established by entering each in a series of passcode characters into one of the configuration cells (109) at one of the grid locations within that configuration cell. For example, the first character in a passcode corresponds to the configuration cell (105-1). The configuration cell (105-1) records the first character in the passcode, as well as a grid location among those in the cell (105-1) where the first character has been entered. The second character in a passcode is established in the next configuration cell (105-2). The third character in a passcode is established in the next configuration cell (105-3). The fourth character in a passcode is established in the next configuration cell (105-4). In this way, a user passcode is set with each character associated with a grid location.

The passcode entry table (101) is populated with a user passcode. The passcode entry table (101) is populated for each use by assigning each possible character to a grid location within a cell in the passcode entry table (101). Each character will appear in multiple locations within the cells of a passcode entry table. Any two appearances of a particular character will be at different grid locations within respective cells. Characters of a passcode are assigned to the passcode entry table (101), such that each character in the passcode can be found in the passcode entry table at each grid location.

A user selects a cell (109) that shows a character of a passcode in the associated grid location (110). A series of cells (109) is selected by the user. The series of cells represent an entered passcode. The passcode authenticator (114) receives the entered passcode, represented by a series of cells selected by the user. The entered passcode is verified by a passcode authenticator (114), which confirms that each character in the passcode matches the content of the associated grid location (112), in the corresponding cell (110) in the entered passcode. A number of unused cells (111) are present in the passcode entry table (101), but not be used in the entry of a passcode. The unused cells (111) allow for the presentation of additional control characters, such as an asterisk (‘*’) or a pound or hash sign (‘#’). The unused cells (111) may present the passcode entry table (101) in a format that is familiar to a user.

The passcode authenticator (114) authenticates a user by verifying that an entered passcode matches a user passcode. The user selects a series of cells in the passcode entry table. Each cell selected by the user corresponds to a character in a user passcode. A passcode authenticator receives the series of cells selected from the passcode entry table. The passcode authenticator verifies that each character in an entered passcode matches both the corresponding character and an associated grid location within a user passcode for an authorized user. As will be described in other parts of this specification, the passcode authenticator (114) utilizes the passcode entry table (101) to protect a user passcode while authenticating a user.

As illustrated, the system (110) includes a passcode authenticator (114). The passcode authenticator (114) may reside on a computing device operated by a user. The passcode authenticator (114) may reside on a separate computing device which communicates with the device being accessed. The passcode authenticator (114) may reside on a single computing device, or may function as part of another system.

The passcode authenticator (114) associates each character of the passcode with a grid location (112) using a number of configuration cells to create a user passcode. During the configuration of a passcode, a number of configuration cells (105), corresponding to a number of characters in a passcode associated with a user, are presented. Each configuration cell (105) includes a grid (108). Each grid forms a plurality of locations. In one example, a user selects a grid location within a configuration cell (205) for each character in a user passcode. In another example, the system displays the grid location for each character in a user passcode. The configuration cells (105) allow for coordination between a user and the passcode authenticator, to configure the grid location (112) associated with each character in a passcode. The configuration cells (105) are displayed during the configuration of a passcode. The configuration cells (105) are not displayed during the entry of a passcode.

The passcode authenticator (114) assigns each possible character to a grid location (110) within a cell (109). Each character will appear in multiple locations within the cells (109) of a passcode entry table (101). Any two appearances of a particular character will be at different grid locations (110) within respective cells (109). Each character will appear in each grid location (110) somewhere in the passcode entry table (101). The passcode authenticator assigns values to the passcode entry table (101) before a passcode is entered. A passcode entry table (101) may be different during each entry of a passcode. The passcode authenticator (114) receives an entered passcode. The entered passcode includes a series of cells. Each cell in the series of cells in the entered passcode corresponds to a character in a user passcode.

The passcode authenticator (114) verifies that each character in a user passcode matches a character in a cell grid location (100). The cell grid location (110) is a grid location matching the grid location associated with each passcode character (112). Each character in the user passcode is verified by matching the character with a character in the corresponding grid location (110) in the corresponding cell (109). When all characters in the user passcode match the characters in the grid location of the corresponding cells, the entered passcode is authenticated.

FIG. 1B illustrates one example of a passcode entry table as described above. As will be described, FIG. 1B illustrates that each character will appear in multiple locations within the cells of a passcode entry table. Any two appearances of a particular character will be at different grid locations within respective cells. The system (150) includes a passcode entry table (160). The passcode entry table (160) communicates with a passcode authenticator (160). The passcode entry table (160) includes a number of cells (170, 171). A number of the cells (170) are used for the entry of a passcode. A number of the cells (171) are used to control the input of a passcode. A user passcode (180) is shown with a number of characters (182).

As illustrated, the character zero is shown in a number of cells (170-3, 170-4, 170-5, 170-10). The character one is shown in a number of cells (170-2, 170-5, 170-7, 170-9). The character three is shown in a number of cells (170-2, 170-3, 170-6, 170-10). The character four is shown in a number of cells (170-1, 170-3, 170-4, 170-8). The character five is shown in a number of cells (170-1, 170-4, 170-5, 170-6). The character six is shown in a number of cells (170-2, 170-3, 170-6, 170-9). The character seven is shown in a number of cells (170-1, 170-5, 170-7, 170-8). The character eight is shown in a number of cells (170-4, 170-7, 170-9, 170-10). The character nine is shown in a number of cells (170-7, 170-8, 170-9, 170-10). The character zero is shown in a number of cells (170-3, 170-4, 170-5, 170-10).

The illustration shows a passcode using a base-ten character set. Each cell (170) contains a grid that forms four grid locations. Each character in the character set appears four times in the passcode entry table (160), matching the number of grid locations. Each character appears in each grid location in a cell in the passcode entry table.

The user passcode (180) shows a user passcode with the characters eight, three, five, and two. Each passcode character (180) is associated with a grid location. The first character (182-1) is character eight. The first character (182-1) is associated with the upper-left grid location. The second character (182-2) is character three. The second character (182-2) is associated with the lower-right grid location. The third character (182-3) is character five. The third character (182-3) is associated with the upper-right grid location. The fourth character (182-4) is character two. The fourth character is associated with the lower-left grid location.

In one example, a user enters a passcode by selecting a series of cells (170). The series of cells (170) is received by the passcode authenticator (164). The user selects a first cell (170-10), a second cell (170-6), a third cell (170-5), and a fourth cell (170-6). The first selected cell (170-6) is compared to the first character (182-1) in the user passcode (180). The first selected cell (170-10) matches the character and grid location of the first character (182-1). The second selected cell (170-6) is compared to the second character (182-2) in the user passcode (180). The second selected cell (170-6) matches the character and grid location of the second character (182-2). The third selected cell (170-5) is compared to the third character (182-3) in the user passcode (180). The third selected cell (170-5) matches the character and grid location of the third character (182-3). The fourth selected cell (170-6) is compared to the fourth character (182-4) in the user passcode (180). The fourth selected cell (170-6) matches the character and grid location of the fourth character (182-4). Each cell selected matches the corresponding character and grid location of the character in the user passcode (180). The passcode authenticator (164) authenticates the user as having entered a correct passcode.

In another example, a user enters a passcode by selecting a series of cells (170). The series of cells (170) is received by the passcode authenticator (164). The user selects a first cell (170-10), a second cell (170-6), a third cell (170-5), and a fourth cell (170-2). As in the previous example, the first cell (170-10), second cell (170-6), and third cell (170-5) match the user passcode (170). The fourth selected cell (170-2) is compared to the fourth character (182-4) in the user passcode (180). The fourth selected cell (170-2) does not match the character and grid location of the fourth character (182-4). The character two is found in the fourth selected cell (170-2), but is not found in the corresponding grid location. The selected cells do not match the corresponding character of the user passcode (180). The user is not authenticated.

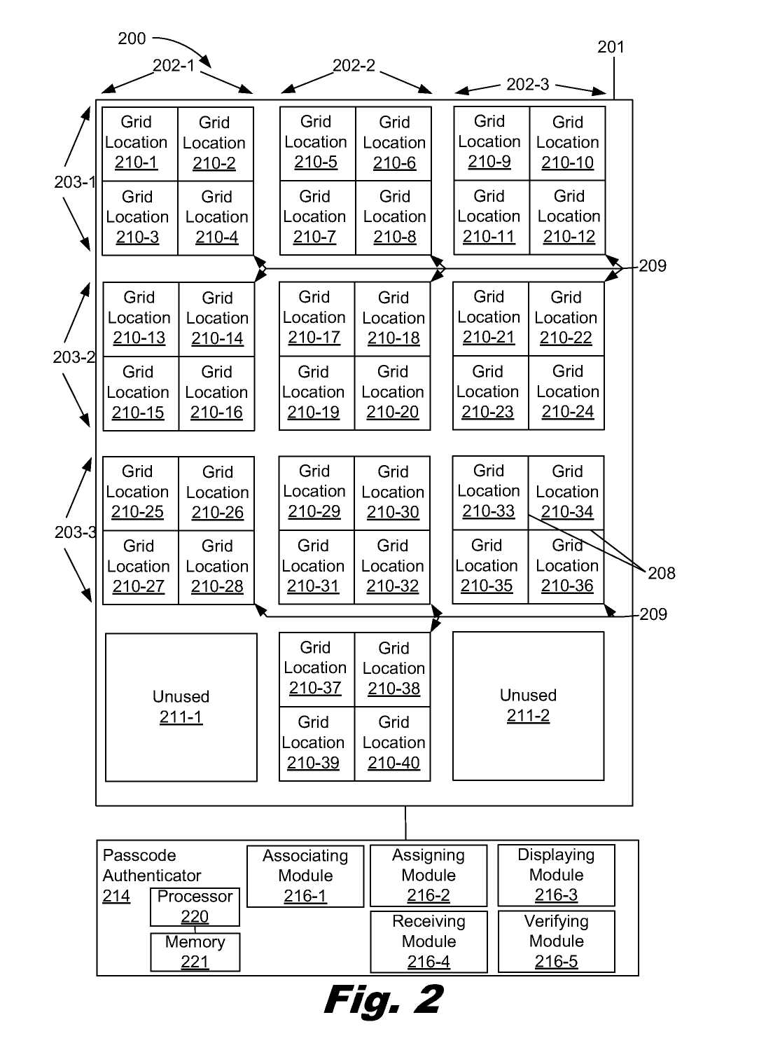

FIG. 2 is illustrates one example of a passcode entry table as described above. As will be described below, the illustrated passcode entry table (201) contains a plurality of cells (209). Each cell (209) contains a grid (208). The grid (208) in each cell (209) creates a plurality of grid locations (210).

The passcode entry table (201) includes a number of cells (209). The passcode entry table (201) has one cell (209) for every possible character in the character set used for the passcode. As illustrated, the passcode entry table (201) is established for a base-ten character set. An example of a base-ten character set is the numbers zero through nine. Each cell (209) contains a grid (208) with four grid locations (210). Each character in the character set is displayed in a grid location (210).

The passcode entry table (201) may display a number of configuration cells during passcode configuration, as previously discussed in FIG. 1A. The configuration cells are displayed during passcode configuration. The configuration cells are not displayed when a passcode is entered. A configuration cell contains a grid. The grid in each configuration cell creates a plurality of grid locations. A passcode contains a series of characters. The passcode is configured using the configuration cells of the passcode table. Each character in the series of characters is associated with a grid location. The series of characters, combined with the associated grid location, creates a user passcode. As illustrated in FIG. 2, the passcode entry table (201) is displayed for the entry of a passcode.

To authenticate a user, the passcode authenticator (214) receives a series of cells selected by a user. Each cell selected by the user corresponds to a character in a user passcode. A passcode authenticator receives the series of cells selected from the passcode entry table. The passcode authenticator (214) confirms that the value in the cell grid location associated with the character in the user passcode, matches the character in the user passcode. When the series of cells received is verified to match a user passcode, the user is authenticated and given access to the device.

As illustrated in FIG. 2, the system (200) includes a passcode entry table (201). The passcode entry table (201) includes a plurality of cells (209). Conceptually, a cell corresponds to the key of a keypad for entering a character of a passcode. Each of the cells (209) includes a grid (208). The grid (208) creates a plurality of grid locations (210) in each cell (209). Each grid location (210) is assigned a character. The cells (210) are arranged into a number of rows (203) and columns (202). As described in FIG. 1A, characters in a passcode are associated with a grid location using a number of configuration cells.

The system (200) includes a passcode authenticator (214). The passcode authenticator (214) may be implemented on a computer system displaying the passcode entry table (201). Alternatively, the passcode authenticator (214) may reside on a computing device that manages information to which a user is attempting to gain access. The passcode authenticator (214) may be implemented as a separate computing device, communicating with a system displaying the passcode entry table (201), and a computing device managing information to which the user is attempting to gain access.

The passcode authenticator (214) includes a processor (220) communicatively connected to memory (221). The passcode authenticator (214) is communicatively connected to the passcode entry table (201). The passcode authenticator (214) includes a number of modules (216). The modules (216) refer to computer program code which, when executed by the processor (220), performs the designated function. As illustrated, the passcode authenticator (214) includes an associating module (216-1), an assigning module (216-2), a displaying module (216-3), a receiving module (216-4), and a verifying module (216-5).

The passcode authenticator (214) includes an associating module (216-1). The associating module (216-1) associates each character of a passcode with a grid location (210) to create a user passcode. Each passcode character is displayed in a configuration cell to communicate to a user a grid location associated with a passcode character. FIG. 1A shows a passcode entry table presented to configure a passcode. Passcode character 112-1 is shown in configuration cell 105-1. Passcode character 112-2 is shown in configuration cell 105-2. Passcode character 112-3 is shown in configuration cell 105-3. Passcode character 112-4 is shown in configuration cell 112-4. The configuration cells communicate the grid location associated with each passcode character to a user. FIG. 2 shows a passcode entry table presented for entry of a passcode. The configuration cells are not shown when a user enters a user passcode.

The passcode authenticator (214) includes an assigning module (216-2). The assigning module (216-2) assigns each possible character to a grid location within a cell. Each character appears in multiple locations with the cells of a passcode entry table. Any two appearances of a particular character will be at different grid locations within respective cells. As illustrated, the passcode entry table is using a base-ten character set. Each character is placed in one of grid locations 210-1, 210-5, 210-9, 210-13, 210-17, 210-21, 210-25, 210-29, or 210-33, 210-37. Each character is placed a second time in one of the grid locations 210-2, 210-6, 210-10, 210-14, 210-18, 210-22, 210-26, 210-30, 210-34, 210-38. Each character is placed a third time in one of the grid locations 210-3, 210-7, 210-11, 210-15, 210-19, 210-23, 210-27, 210-31, 210-35, 210-39. Each character is placed a fourth time in 210-4, 210-8, 210-12, 210-16, 210-20, 210-24, 210-28, 210-32, 210-36, 210-40.

The passcode authenticator (214) includes a displaying module (216-3). The displaying module (216-3) displays the passcode entry table (201) on a computer display. The passcode entry table (201) shows each character in each grid location (210) in each cell (209) in the passcode entry table (201). The displaying module (216-3) displays the passcode entry table (201) as illustrated. The displaying module (216-3) shows a number of rows (203) and a number of columns (202) of cells (209).

The passcode authenticator (214) includes a receiving module (216-4). The receiving module (21605) receives an entered passcode. The entered passcode includes a series of cells. Each cell in the series of cells corresponds to a character in a user passcode.

The passcode authenticator (214) includes a verifying module (216-5). The verifying module (216-5) verifies that each character in the user passcode matches a character in a grid location (210). The grid location is a grid location (210) associated with the character in the user passcode. As previously discussed, each character in the user passcode is associated with a grid location (210). The verifying module (216-6) examines a cell (209) in the series of cells. The verifying module (216-5) compares each character in the passcode to a corresponding cell (209) in the series of cells. The verifying module (216-5) verifies that the character in the entered passcode and the cell that corresponds to the passcode character have the same value in the grid location associated with the user passcode character. When all characters in a user passcode match the character in the corresponding grid location in the corresponding cell, the entered passcode is used to authenticate the user.

An overall example of FIG. 2 will now be described. A user with a passcode uses the passcode authenticator (214). The passcode authenticator (214) configures the passcode to associate a grid location (210) with each character in the passcode. Characters are assigned in the passcode entry table (201). The passcode entry table (201) is presented to a user. A user selects a series of cells. The passcode authenticator (214) receives the series of cells and verifies that the series of cells represents the user passcode.

The associating module (216-1) associates each passcode character (FIG. 1A, 112) with a grid location. The association of passcode characters and grid locations is shown as part of FIG. 1A. A passcode character (FIG. 1A, 112-1) is associated with the upper-left grid location (FIG. 1A, 130) of a cell. A passcode character (FIG. 1A, 112-2) is associated with the lower-left grid location of a cell (105-2). A passcode character (FIG. 1A, 112-3) is associated with the upper-right grid location of a cell (FIG. 1A, 105-3). A passcode character (FIG. 1A, 112-4) is associated with the upper-right grid location of a cell (FIG. 1A, 105-4). The associating module (216-1) presents the configuration cells (FIG. 1A, 105) to a user to inform the user of the grid locations used. FIG. 2 shows a passcode entry table displayed for the entry of a passcode. The user is entering a passcode, so the configuration cells are not displayed.

The assigning module (216-2) assigns each possible character in the character set to a grid location within a cell. Each character appears in multiple locations with the cells of a passcode entry table. Any two appearances of a particular character will be at different grid locations within respective cells. As illustrated, each character is placed in one of grid locations 210-1, 210-5, 210-9, 210-13, 210-17, 210-21, 210-25, 210-29, or 210-33, 210-37. Each character is placed a second time in one of the grid locations 210-2, 210-6, 210-10, 210-14, 210-18, 210-22, 210-26, 210-30, 210-34, 210-38. Each character is placed a third time in one of the grid locations 210-3, 210-7, 210-11, 210-15, 210-19, 210-23, 210-27, 210-31, 210-35, 210-39. Each character is placed a fourth time in one of the grid locations 210-4, 210-8, 210-12, 210-16, 210-20, 210-24, 210-28, 210-32, 210-36, 210-40.

The displaying module (216-3) displays the passcode entry table (201). The passcode entry table (201) is displayed by displaying the cells (209) that make up the passcode entry table. The cells (209) are displayed in rows (203) and columns (202). Each cell is displayed with the plurality of grid locations (210). Each grid location (210) is displayed as the character assigned to the grid location (210).

The receiving module (216-5) receives an entered passcode. The entered passcode includes a series of cells (209). The series of cells (209) is selected by a user. Each cell in the series of cells (209) corresponds to a character in a user passcode.

The verifying module (216-6) verifies that each sequentially selected cell matches a corresponding character of the passcode. The verifying module (216-6) verifies that the corresponding character of the passcode matches that character displayed at a corresponding grid location within the selected cell. When the character in the corresponding grid location of the sequentially selected cells does not match the corresponding character of the passcode the entry of the passcode is not authenticated

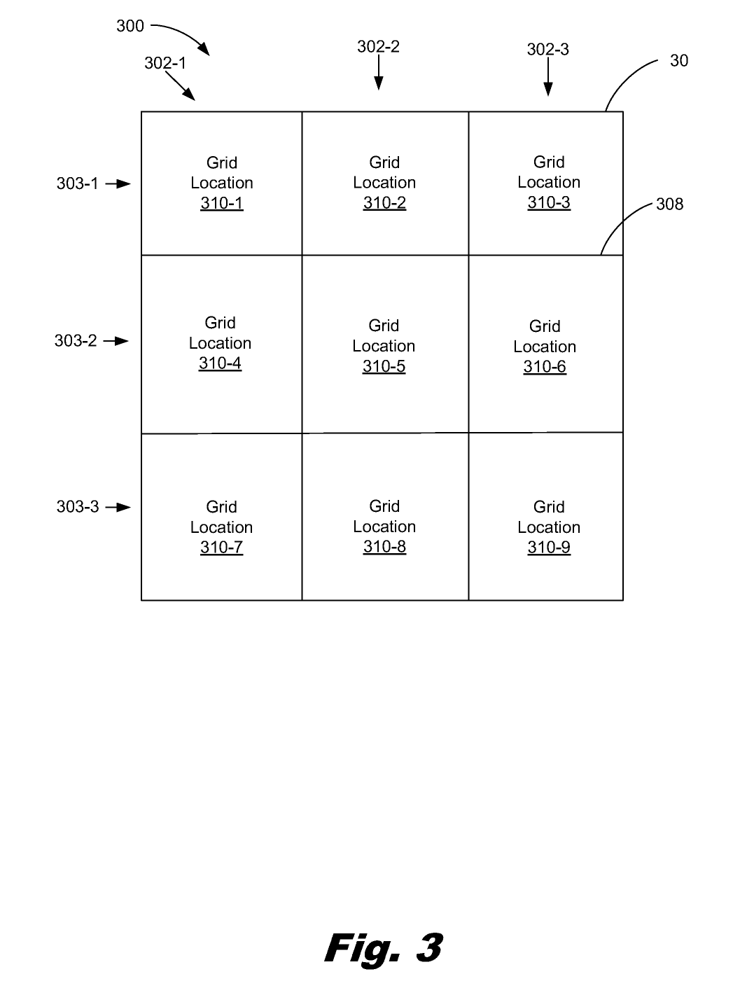

FIG. 3 is illustrates one example of a diagram of a cell with a grid creating a number of grid locations. The cell is used in the passcode entry table (FIG. 2, 201) to authenticate a passcode.

The cell (309) contains a grid (308). The grid creates a plurality of grid locations (310). The grid locations (310) are organized into a number of rows (303) and columns (302). As illustrated, the cell (309) has three rows (303) and three columns (302). The row (303-1) includes grid locations (310-1, 310-2, 310-3). The row (303-2) includes grid locations (310-4, 310-5, 310-6). The row (303-3) includes grid locations (310-7, 310-8, 310-9). The column (302-1) includes grid locations (310-1, 310-4, 310-7). The column (302-2) includes grid locations (310-2, 310-5, 310-8). The column (302-3) includes grid locations (310-3, 310-6, 310-9).

The principles described herein allow a cell to have any number of rows and columns that form a plurality of grid locations. As passcode entry table for a base-ten character set using the cell (309) format would have each character in the character set appear nine times. As previously described, a character is assigned to each grid location. Each grid location in each cell is assigned a character. Any two of the same grid locations in different cells will have different characters.

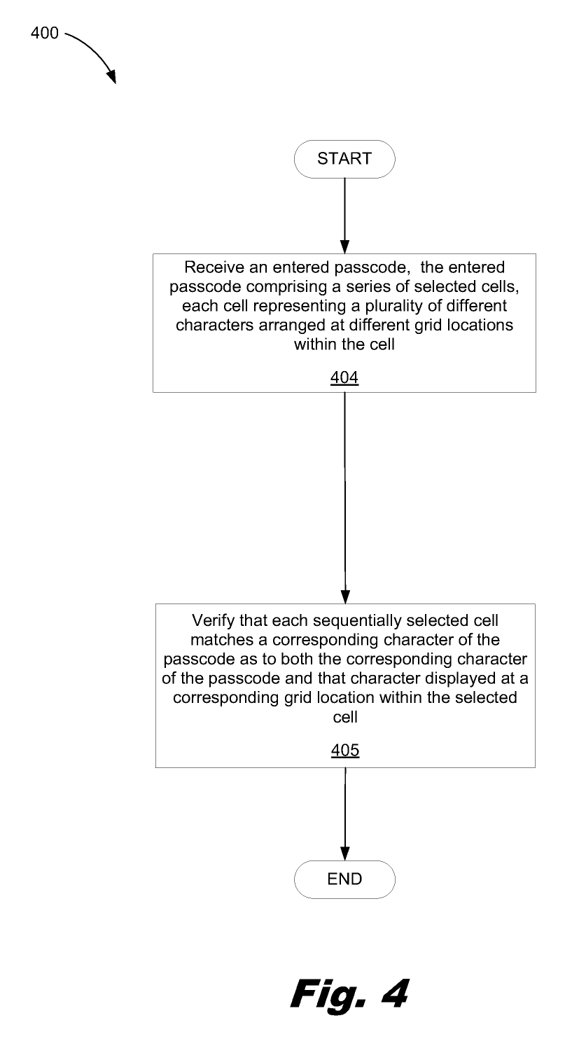

FIG. 4 illustrates one example of a flow chart of a method implemented by a user authentication system. The method (400) may be executed by the passcode authenticator of FIG. 1A. The method may be executed by other systems (i.e. system 200, system 600, system 700). As illustrated, the method (400) includes receiving (block 405) an entered passcode. The entered passcode includes a series of cells. The method (400) includes verifying (block 406) that each character in a user passcode matches a character in a grid location. The grid location is a grid location associated with the passcode character in a corresponding cell in the entered passcode.

As mentioned above, the method (400) includes receiving (block 404) an entered passcode. The entered passcode comprises a series of cells. Each cell in the series of cells corresponds to a character in a user passcode.

As mentioned above, the method (400) includes verifying (block 405) that each sequentially selected cell matches a corresponding character of the passcode, as to both the corresponding character of the passcode and that character displayed at a corresponding grid location within the selected cell. When the sequentially selected cell does not match the corresponding character of the passcode as to both the character and the grid location corresponding to the character, the entry of the passcode is not authenticated. The verifying (block 405) verifies that the character in the entered passcode and the cell that corresponds to the passcode character have the same value in the grid location associated with a user passcode character. When a user provides an entered passcode that is verified to match a user passcode, the user is authenticated and given permission to proceed with using the device or information protected by the device.

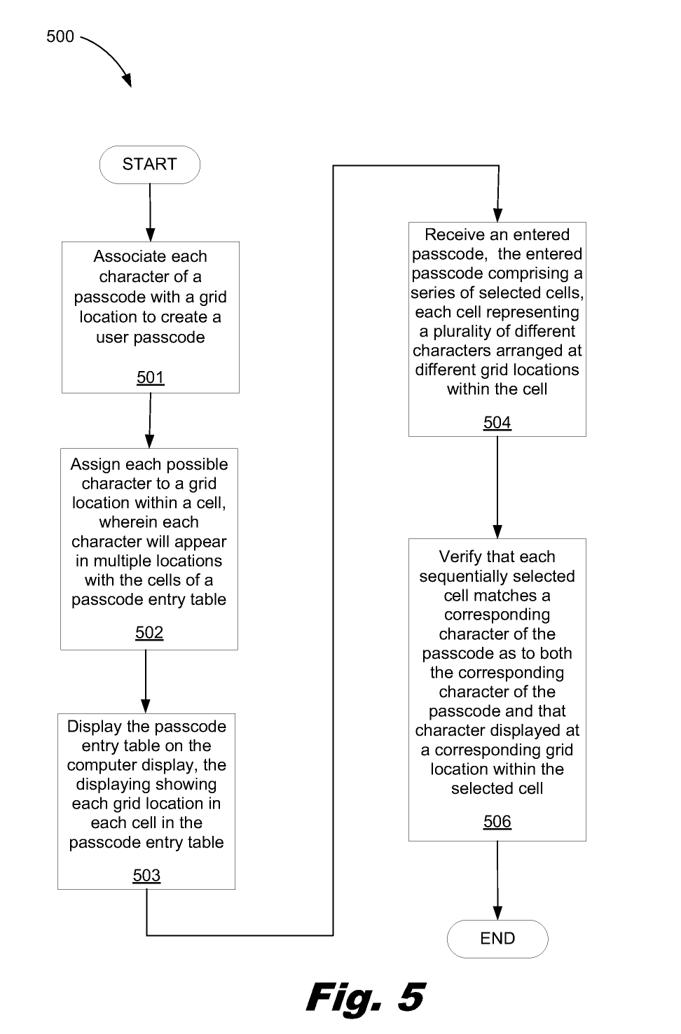

FIG. 5 illustrates one example of a flow chart of a method implemented by a user authenticating system. The method (500) may be executed by the passcode authenticator of FIG. 1A. The method may be executed by other systems (i.e. system 200, system 600, system 700). As illustrated, the method (500) includes associating (block 501) each character of a passcode with a grid location to create a user passcode. The method (500) includes assigning (block 502) each possible character to a grid location within a cell. Each character appears in multiple locations with the cells of a passcode entry table. Any two appearances of a particular character will be at different grid locations within respective cells. The method (500) includes displaying (block 503) the passcode entry table. The displaying (block 503) shows each grid location in each cell in the passcode entry table. The method (500) includes receiving (block 504) an entered passcode. The entered passcode includes a series of selected cells. Each cell represents a plurality of different characters arranged at different grid locations within the cell. The method (500) includes verifying (block 505) that each sequentially selected cell matches a corresponding character of the passcode as to both the corresponding character of the passcode and that character displayed at a corresponding grid location within the selected cell. When the sequentially selected cells do not match the corresponding characters of the passcode as to both the character and the grid location corresponding to the character, the entry of the passcode is not authenticated.

As mentioned above, the method (500) includes associating (block 501) each character of a passcode with a grid location to create a user passcode. Each passcode character is displayed in a configuration cell to associate a grid location with a passcode character. The associating (block 501) may allow a user to select a grid location for each character in the passcode. The associating (block 501) may present to the user a grid location associated with each passcode character. The configuration cells are not shown when a user enters a user passcode.

As mentioned above, the method (500) includes assigning (block 502) each possible character to a grid location within a cell. Each character will appear in multiple locations within the cells of a passcode entry table. Any two appearances of a particular character will be at different grid locations within respective cells. The character of the passcode will be seen by a user in the corresponding grid location of a cell. The cell is selected by a user to indicate the character of the entered passcode.

As mentioned above, the method (500) includes displaying (block 503) the passcode entry table. The displaying (503) shows each grid location in each cell in the passcode entry table. The passcode entry table is presented to a user such that the user may observe each cell and select a cell where a passcode character has been assigned to a corresponding grid location.

As mentioned above, the method (500) includes receiving (block 504) an entered passcode. The entered passcode includes a series of selected cells. Each cell represents a plurality of different characters arranged at different grid locations within the cell. As mentioned above, the method (500) includes verifying (block 505) that each sequentially selected cell matches a corresponding character of the passcode, as to both the corresponding character of the passcode, and that character displayed at a corresponding grid location within the selected cell. When the sequentially selected cell does not match the corresponding character of the passcode as to both the character and the grid location corresponding to the character, the entry of the passcode is not authenticated.

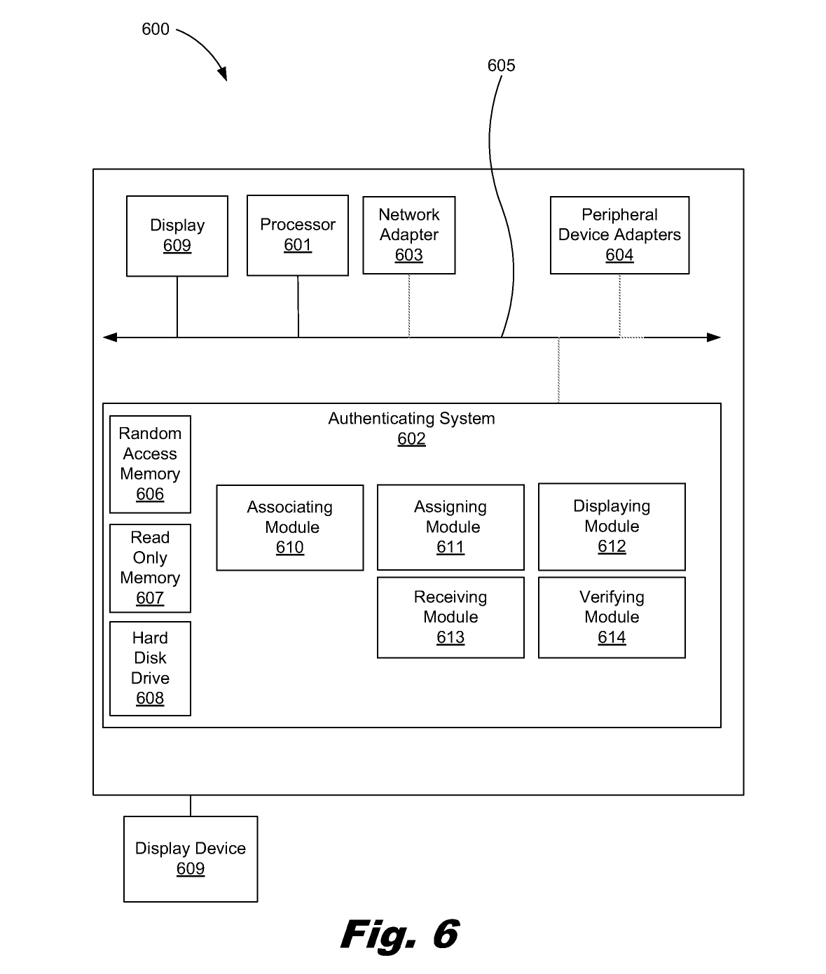

FIG. 6 illustrates one example of a computing device for authenticating a user with a passcode. The computing device (600) for authenticating a user with a passcode may be implemented by an electronic device. Examples of electronic devices include servers, desktop computers, laptop computers, personal digital assistants (PDAs), mobile devices, smartphones, gaming systems, and tablets, among other electronic devices.

The computing device (600) may be utilized in any data-processing scenario, including stand-alone hardware, mobile applications, a computing network, or combinations thereof. Further, the computing device (600) may be used in a computing network, a public cloud network, a private cloud network, a hybrid cloud network, other forms of networks, or combinations thereof. In one example, the methods provided by the computing device (600) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, networks, and components, among others; an application program interface (API), or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the computing device (600) are executed by a local administrator.

To achieve its desired functionality, the computing device (600) may include various hardware components. Among these hardware components may be a number of processors (601), an authenticating system (602), a number of peripheral adapters (604), and a number of network adapters (603). These hardware components may be interconnected through the use of a number of buses and/or network connections. In one example, the processor (601), authenticating system (602), peripheral device adapters (604), and network adapter (603) may be communicatively coupled via a bus (605).

The computing device (600) may include various types of memory modules, including volatile and nonvolatile memory. For example, the authenticating system (602) may include Random Access Memory (RAM) (606), Read Only Memory (ROM) (607), and Hard Disk Drive (HDD) memory (608). Many other types of memory may also be utilized, and the present specification contemplates the use of as many varying type(s) of memory in the computing device (600) as may suit a particular application of the principles described herein. In other examples, different types of memory in the computing device (600) may be used for different data storage needs. In some examples, the processor (601) may boot from Read Only Memory (ROM) (607), maintain nonvolatile storage in the Hard Disk Drive (HDD) memory (608), and execute program code stored in Random Access Memory (RAM) (606).

Generally, the computing device (600) may comprise a computer readable medium, a computer readable storage medium, or a non-transitory computer readable medium, among others. For example, the computing device (600) may be, but is not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store computer usable program code for use by, or in connection with, an instruction execution system, apparatus, or device. In another example, a computer readable storage medium may be any non-transitory medium that can contain or store a program for use by, or in connection with, an instruction execution system, apparatus, or device.

The hardware adapters (603, 604) in the computing device (600) enable the processor (601) to interface with various other hardware elements, external and internal to the computing device (600). The peripheral device adapters (604) may provide an interface to input/output devices, such as a display device (609), a mouse, or a keyboard. The peripheral device adapters (603) may also provide access to other external devices, such as an external storage device, a number of network devices, such as servers, switches, and routers, client devices, other types of computing devices, or combinations thereof.

The display device (609) may be provided to allow a user of the computing device (600) to interact with and implement the functionality of the computing device (600). The peripheral device adapters (604) may also create an interface between the processor (601) and the display device (609), a printer, or other media output devices. The network adapter (603) may provide an interface to other computing devices within, for example, a network, thereby enabling the transmission of data between the computing device (600) and other devices located within the network.

The authenticating system (602) may include a number of modules used in the authentication of a user using a passcode entry table. The various modules within the computing device (600) comprise executable program code that may be executed separately. The various modules may be stored as separate computer program products. The various modules within the computing device (600) may be combined within a number of computer program products; each computer program product comprising a number of the modules.

The computing device includes an associating module (610) to associate each character of a passcode with a grid location to create a user passcode. The computing device includes an assigning module (611) to assign each possible character to a grid location within a cell. Each character appears in multiple locations with the cells of a passcode entry table. Any two appearances of a particular character will be at different grid locations within respective cells. The computing device includes a displaying module (612) to display the passcode entry table. The displaying showing each grid location in each cell in the passcode entry table. The computing device includes a receiving module (613) to receive an entered passcode. The entered passcode comprises a series of selected cells, each cell representing a plurality of different characters arranged at different grid locations within the cell. The computing device includes a verifying module (614) to verify that each sequentially selected cell matches a corresponding character of the passcode as to both the corresponding character of the passcode, and that character displayed at a corresponding grid location within the selected cell. When the sequentially selected cell does not match the corresponding character of the passcode as to both the character and the grid location corresponding to the character, the entry of the passcode is not authenticated.

The associating module (610) associates each character of a passcode with a grid location to create a user passcode. A passcode character and grid location combination includes additional information to be provided when the passcode is entered, as compared to entering only the passcode. The additional information increases the security of the passcode, as well as preventing others from observing the passcode.

The assigning module (611) assigns each possible character to a grid location within a cell. Each character will appear in multiple locations within the cells of a passcode entry table. Any two appearances of a particular character will be at different grid locations within respective cells.

The displaying module (613) displays the passcode entry table, the displaying showing each grid location in each cell in the passcode entry table. The passcode entry table is displayed to a user, such that a user may select a series of cells representing an entered passcode.

The receiving module (614) receives an entered passcode, the entered passcode comprising a series of selected cells. Each cell represents a plurality of different characters arranged at different grid locations within the cell. The entered passcode, entered by a user, provides the passcode authenticator with information from a user to authenticate the user.

The verifying module (615) verifies that each sequentially selected cell matches a corresponding character of the passcode, as to both the corresponding character of the passcode and that character displayed at a corresponding grid location within the selected cell. When the sequentially selected cells do not match the corresponding characters of the passcode as to both the characters and the grid locations corresponding to the characters, the entry of the passcode is not authenticated. When the entry of the passcode is not authenticated, the user is not authenticated. An entered passcode that matches a user passcode indicates the user is an approved user. The user is authenticated and allowed to use the system to which access was sought.

Aspects of the present system and method are described herein with reference to flowchart illustrations and/or block diagrams of methods, apparatus (systems) and computer program products, according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (601) of the computing device (600) or other programmable data processing apparatus, implements the functions or acts specified in the flowchart and/or block diagram block or blocks.

The computer usable program code may be embodied within a computer readable storage medium; the computer readable storage medium being part of the computer program product. The computer readable storage medium may be a non-transitory computer readable medium.

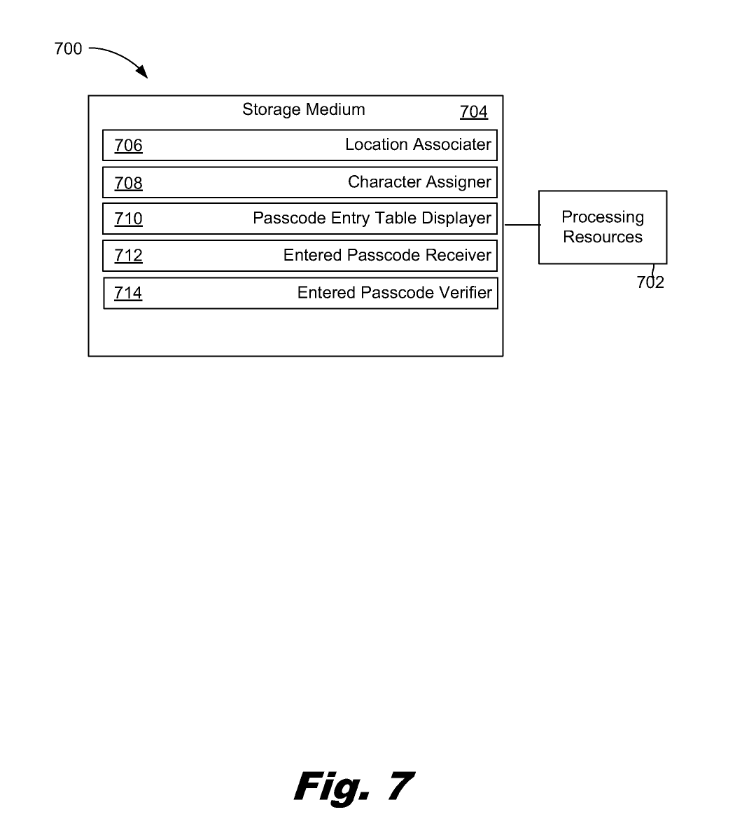

FIG. 7 illustrates one example of a diagram of a passcode authenticating system (700). The passcode authenticating system (700) includes processing resources (702) that are in communication with memory resources (704). The processing resources (702) include at least one processor and other resources used to process programmed instructions. The memory resources (704) generally represent any memory capable of storing data, such as programmed instructions or data structures to be used by the transferring system (700). The programmed instructions shown stored in the memory resource (704) include a location associater (706), a character assigner (708), a passcode entry table displayer (710), an entered passcode receiver (712), and an entered passcode verifier (714).

The location associater (706) represents programmed instructions that, when executed, cause the processing resource (702) to associate each character of a passcode with a grid location to create a user passcode.

The character assigner (708) represents programmed instructions that, when executed, cause the processing resource (702) to assign each possible character to a grid location within a cell, wherein each character will appear in multiple locations within the cells of a passcode entry table. Any two appearances of a particular character will be at different grid locations within respective cells.

The passcode entry table displayer (710) represents programmed instructions that, when executed, cause the processing resource (702) to display the passcode entry table. The displaying shows each grid location in each cell in the passcode entry table.

The entered passcode receiver (714) represents programmed instructions that, when executed, cause the processing resource (702) to receive an entered passcode. The entered passcode includes a series of selected cells. Each cell represents a plurality of different characters arranged at different grid locations within the cell.

The entered passcode verifier (716) represents programmed instructions that, when executed, cause the processing resource (702) to verify that each sequentially selected cell matches a corresponding character of the passcode, as to both the corresponding character of the passcode and that character displayed at a corresponding grid location within the selected cell. When the sequentially selected cell does not match the corresponding character of the passcode as to both the character and the grid location corresponding to the character, the entry of the passcode is not authenticated.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicates otherwise. It will be further understood that the terms “comprises” and/or “comprising,” when used in the specification, specify the presence of stated features, integers, operations, elements, and/or components, but do not preclude the presence or addition of a number of other features, integers, operations, elements, components, and/or groups thereof.

What is claimed is:

1. A computer implemented method for authenticating a user with a passcode, the passcode comprising a sequence of characters and a location within a grid associated with each character, wherein entry of the passcode is performed using a displayed passcode entry table comprising a number of selectable cells, where selection of a cell enters a character of a passcode being entered, each cell including a number of different characters in different grid locations displaced within the cell, such that the entry of one particular character in the passcode is made by selecting a cell, the corresponding display of which includes the particular character of the passcode displayed at the correct corresponding grid location within the cell, the method comprising:
receiving an entered passcode, the entered passcode comprising a series of selected cells, each cell representing a plurality of different characters arranged at different grid locations within the cell; and,
verifying that each sequentially selected cell matches a corresponding character of the passcode, as to both the corresponding character of the passcode and that character displayed at a corresponding grid location within the selected cell,
wherein, when the sequentially selected cell does not match the corresponding character of the passcode as to both the character and the grid location corresponding to the character, the entry of the passcode is not authenticated.

2. The method of claim 1, further comprising assigning each possible character to a grid location within a cell, wherein each character will appear in multiple locations within the cells of the passcode entry table, wherein two appearances of a particular character will be at different grid locations within respective cells.

3. The method of claim 1, further comprising displaying the passcode entry table, the displaying showing each grid location in each cell in the passcode entry table.

4. The method of claim 1, further comprising associating each character of the passcode with a grid location to create a user passcode.

5. The method of claim 1, wherein the passcode entry table comprises a number of rows and a number of columns of cells.

6. The method of claim 1, wherein the grid comprises a number of rows and a number of columns of grid locations.

7. The method of claim 1, wherein a number of cells presented as part of the passcode entry table are blocked from use in entering a passcode.

8. A system for authenticating a user with a passcode, the passcode comprising a sequence of characters and a location within a grid associated with each character, wherein entry of the passcode is performed using a displayed passcode entry table comprising a number of selectable cells, where selection of a cell enters a character of a passcode being entered, each cell including a number of different characters in different grid locations displaced within the cell, such that the entry of one particular character in the passcode is made by selecting a cell, the corresponding display of which includes the particular character of the passcode displayed at the correct corresponding grid location within the cell, the system comprising:
a processor;
memory, communicatively connected to the processor;
a computer display, displaying information directed by the processor;
a passcode authenticating system, the passcode authenticating system comprising:
an associating module, to associate each character of a passcode with a grid location to create a user passcode;
an assigning module, to assign each possible character to a grid location within a cell, wherein each character will appear in multiple locations within the cells of a passcode entry table, wherein two appearances of a particular character will be at different grid locations within respective cells;
a displaying module, to display the passcode entry table, the displaying showing each grid location in each cell in the passcode entry table;
a receiving module, to receive an entered passcode, the entered passcode comprising a series of selected cells, each cell representing a plurality of different characters arranged at different grid locations within the cell; and,
a verifying module, to verify that each sequentially selected cell matches a corresponding character of the passcode as to both the corresponding character of the passcode and that character displayed at a corresponding grid location within the selected cell, wherein, when the sequentially selected cell does not match the corresponding character of the passcode as to both the character and the grid location corresponding to the character, the entry of the passcode is not authenticated.

9. The system of claim 8, wherein each of the number of characters is a number.

10. The system of claim 8, wherein the passcode entry table comprises a number of rows and a number of columns of cells.

11. The system of claim 8, wherein the grid comprises a number of rows and a number of columns of grid locations.

12. The system of claim 8, wherein a number of cells presented as part of the passcode entry table are blocked from use in entering a passcode.

13. A computer program product for authenticating a user with a passcode, the passcode comprising a sequence of characters and a location within a grid associated with each character, wherein entry of the passcode is performed using a displayed passcode entry table comprising a number of selectable cells, where selection of a cell enters a character of a passcode being entered, each cell including a number of different characters in different grid locations displaced within the cell, such that the entry of one particular character in the passcode is made by selecting a cell, the corresponding display of which includes the particular character of the passcode displayed at the correct corresponding grid location within the cell, the computer program product comprising:
a non-transitory tangible computer readable storage medium, said tangible computer readable storage medium comprising computer readable program code embodied therewith, said computer readable program code comprising program instructions that, when executed, cause a processor to:
receive an entered passcode, the entered passcode comprising a series of selected cells, each cell representing a plurality of different characters arranged at different grid locations within the cell; and,
verify that each sequentially selected cell matches a corresponding character of the passcode as to both the corresponding character of the passcode and that character displayed at a corresponding grid location within the selected cell, wherein, when the sequentially selected cell does not match the corresponding character of the passcode as to both the character and the grid location corresponding to the character, the entry of the passcode is not authenticated.

14. The computer program product of claim 13, further comprising computer readable program code that, when executed, causes the processor to:
associate each character of the passcode with a grid location to create a user passcode.

15. The computer program product of claim 13, further comprising computer readable program code that, when executed, causes the processor to:
assign each possible character to a grid location within a cell, wherein each character will appear in multiple locations within the cells of a passcode entry table, wherein two appearances of a particular character will be at different grid locations within respective cells.

16. The computer program product of claim 13, wherein each character is a number.

17. The computer program product of claim 13, wherein the passcode entry table comprises a number of rows and a number of columns of cells.

18. The computer program product of claim 13, wherein the grid comprises a number of rows and a number of columns of grid locations.

19. The computer program product of claim 13, wherein a number of cells presented as part of the passcode entry table are blocked from use in entering a passcode.

20. The computer program product of claim 13, wherein a plurality of characters of the passcode are assigned to a cell in the passcode entry table.
